(19) United States
(12) Patent Application Publication
(10) Pub. No.: US 2007/0006129 A1
(43) Pub. Date: Jan. 4, 2007

(54) Forming of a data retrieval, searching from a data retrieval system, and a data retrieval system

(75) Inventors: Marko Cieslak, Tampere (FI); Jari Vuomajoki, Tampere (FI)

Correspondence Address: VENABLE LLP, P.O. BOX 34385, WASHINGTON, DC, 20043-9998, US

(73) Assignee: OPASMEDIA OY, Tampere (FI)

(21) Appl. No.: 11/141,197

(22) Filed: Jun. 1, 2005

(51) Int. Cl. G06F 9/44; G06F 9/45

(52) U.S. Cl. 717/104; 717/112; 717/141

(57) ABSTRACT

The present invention relates to a data retrieval system as well as a method for creating the same, as well as a method for searching therein. Furthermore, the invention relates to computer software products. In the data retrieval system, the searchable data has been converted to concepts, wherein the search is also carried out by means of the concepts. The searchable data formed into concepts is stored as a structure in which the data content segments containing each concept are stored ready in various orders.

### FIELD OF THE INVENTION

The present invention relates to searching of data in a data content by means of search terms. The invention comprises a method for forming a data retrieval system and a method for searching in the data retrieval system, a data retrieval system and a computer software product for both methods, as well as a data structure.

### BACKGROUND OF THE INVENTION

It is possible to carry out data searches in data in electrical form by means of various search services. The object of the data search may be electrical documents or files, based on, for example, their contents or qualifiers. Depending on the storage system, there are different ways of searching for documents and files. For the storage of large data units, for example various types of databases have been developed, comprising ready functions to facilitate searches.

A data storage, such as a database, is designed, constructed and stored for a given purpose. A method for carrying out a search in a database can be selected on the basis of the accuracy of the searchable data and the size of the database. A fast-access search (i.e. a specified search) gives a reply to a quick search question, wherein the set of results is concise and easy to process. Thus, the person searching for data must know, for example, a precise qualifier of the searchable data, such as a numerical code, for example postal codes and numerical keys etc., or a part of the characteristic data sequence of the qualifier.

Searches in Internet wide data can be carried out, for example, by using information retrieval systems, such as Google™ and Altavista™. Such retrieval systems make it possible to search the Internet by maintaining separate databases on web pages. The retrieval function is implemented by a user interface in which one or several search terms are entered in the retrieval system. By means of these search terms, the retrieval system carries out a search in the database. The results comprise references to such documents and files in which the search term or terms occur, and these results are displayed to the user in the user interface. In some retrieval systems, the searches can be carried out on the basis of an entire name or phrase, or by using for example Boolean search, in which the search terms are connected by logical operators (AND, OR, NOT).

In general, the search is implemented by the search terms in the form in which the search term is presented. If the search of different forms of the word is to be carried out, many retrieval systems provide the option of cutting the word, wherein the various suffixes of inflection of the words can be scanned through faster than by separating these word-suffix combinations with the operation OR. Cutting the word is an important element particularly for searching in databases in the Finnish language (or other languages belonging to an agglutinating language group), because the nouns of these languages have several inflections. A corresponding situation also comes up in connection with the plural suffixes or the conjugations of verbs in other languages. When finishing the search, one must think of the point where to cut the search term. For example, it is a problem in the Finnish language that the inflection of a word may change the written form of the stem word, or when the word is cut, it is too short, in which case the search also covers words which should not be included. For example, in the system of inflection of the Finnish language, the inflection of the words is bound to the stem word, thereby forming a new independent word (“poja|Ile”), whereas in Indoeuropean language systems (including English), the inflections are replaced by prefixes and/or suffixes (“to the boy”). By using prefixes and suffixes, the stem word can be maintained intact (“boy”), whereas in the Finnish language, the stem word (“poika”) disappears from the inflected word. For this reason, searches in the Finnish language may give fewer search results than searches carried out, for example, in the English language.

Today, several electrical retrieval systems are international, and searches can be carried out in different languages by defining the search terms in these languages. Thus, the search term “kissa” is used to produce search results in which the Finnish word “kissa” occurs. The search term “cat” produces search results in which the English word “car” occurs. If both words are to be included in the search to produce either “cat” results or “kissa” results, the search term must be defined to include both words (for example, kissa OR cat).

As existing retrieval systems search for hits in databases on the basis of the entered search term, it is obvious that e.g. synonyms are omitted. If documents are searched with the search term “rabbit”, documents which only include the word “bunny”, “hare” or “cottontail” are bypassed when the above-mentioned words were intended to be parallelled as meaning the same thing.

In the development of retrieval systems, we are now facing a situation in which the retrieval systems of more comprehensive databases tend to increase the quantity of searchable data in their databases. The development of information retrieval methods has thus received less attention. Consequently, the applicant is not aware of any implementations of, for example, retrieval methods for carrying out searches for concepts or contexts irrespective of the data format. There is thus a need for a retrieval method and system for both carrying out a search with the concepts, and taking into account the above-mentioned features related to different languages.

### SUMMARY OF THE INVENTION

The aim of the present invention is to provide a solution to meet the above-described need. By means of the retrieval method provided by the invention, search argument data finds the references that are relevant for the search in the searchable data, regardless of whether the searchable data and the search argument data are congruent with respect to the characters and the linguistic form. Consequently, the retrieval method according to the invention produces a set of search results which comprises both the results corresponding to the search term and the results corresponding to other terms in the context of the search term, as well as possibly also search results in different languages. As a result, the advantage is achieved that the set of search results may be significantly larger and more comprehensive than when using conventional retrieval methods. On the other hand, the set of search results may be more concise, because when interpreting the concepts of the search in more detail, it excludes irrelevant search results more accurately than the present systems. In both cases, the benefit is significant.

To achieve these aims, the invention relates to a method for forming an information retrieval system in which a data content is received and concepts are defined for the expressions occurring in the data content, wherein the received data content is converted by forming corresponding concepts for the expressions, and as a result, creating at least one structure that comprises the concepts describing the expressions of the data content as well as the locations of these concepts in said data content.

In the method for carrying out a data search in said information retrieval system, concepts are searched for one or more search terms occurring in the search argument data, search criteria are formed by means of at least the concepts to search for the locations corresponding to said one or more concepts included the data content in said at least one structure.

The information retrieval system comprises control means for defining the search argument data and the searchable data, interpreting means for converting the search argument data and the searchable data into concepts, as well as at least one structure for storing the data content in concept form.

The data structure comprises order indices describing the orders of occurrence, as well as identifications describing the data of the data content, wherein each identification can be used to search for the data content segments including said identification in the order of occurrence indicated by the order index.

A computer software product for forming an information retrieval system comprises computer executable instructions which are adapted to receive a data content and to define concepts for the expressions occurring in said data content, and further to convert the received data content by forming corresponding concepts for said expressions, with the result of creating at least one structure that includes the concepts describing the expressions of the data content as well as the locations of these concepts in said data content.

A computer software product for carrying out a data search, the computer software product comprising computer executable instructions to search for concepts for one or more search terms occurring in the search argument data, to form search criteria by means the concepts to search for the locations corresponding to said one or more concepts included the data content in the structure.

The dependent claims will present some preferred embodiments of the invention.

Consequently, the present invention provides an arrangement for building up a retrieval system that interprets data. In the retrieval system, conceptual equivalents are defined for data in the data contents, by using concept identifications. The concept identifications for the data contents are stored in a parallel data structure. The structure is a storage not only for the concepts but also for a location reference to the data of the data content, of which the concept consists, as well as for possible links to other concepts.

The search operation itself can be formed as a combination of several concepts. Before forming the search operation, the search argument data is interpreted as concept identifications in the same way as the data of the data contents has been interpreted during the formation of the concept data structure. The search is only carried out for the concepts and the possible concepts linked to the concept, wherein the format of data in the data concepts is not a factor limiting the search.

The control system controlling the search operation decides on the interpretation of the concepts of the search argument data case by case. The way of interpreting different terms into the same concepts is specific to the case and the retrieval system. It may occur that even synonyms are not always interpreted as the same concept. For this reason, retrieval systems (and control systems) can be formed for different usage purposes according to the case and subject field, wherein the different control systems can interpret the terms and concepts in different ways.

The invention provides significant advantages to the present retrieval systems. The most important advantage is the fact that the bulk of data is searched as concepts, interpreting the contexts. Consequently, the search is not limited to the comparison of, for example, character strings, but it finds the correct results even if they are expressed in different ways. An example to be mentioned is the use of different sentence structures, inflections and synonyms. In other words, the search is carried out by means of the concept identifications of the searching data by comparing them with the concept identifications of the searchable data as well as links to the searchable data. When the concepts expressed in different languages mean the same thing, the search can also be made in material in a different language, if desired. Consequently, the retrieval method is independent of the language.

In the retrieval system, data is transferred in a format as concise as possible, because this is profitable as long as the data transmission between the different parts of the system is slower than the process of compression and decompression. Therefore, in the solution according to the invention, as many things as possible have been done so that if it has been possible to reduce any data in the system, for example by compressing the data into a format with a smaller size, this has been done. Consequently, a significant speed has been achieved for the data transmission and the presentation of the search results. In addition, the search argument data is further compressed by the reduction of the search argument data and its conversion into concept identifications: in an ideal situation, a whole sentence can be converted to a single FIGURE of, for example, 32 bits. In this way, the data can be compressed into a significantly more compact packet.

Furthermore, in the retrieval system, many operations have been carried out in advance, such as the computation of the number of search results for each concept.

With the present invention, it is possible to achieve semantic and conceptual intelligence for carrying out the search operation, because the retrieval system can evaluate which search results the user will want in addition to those given in the search entry.

A retrieval system of the type of the invention can be used by any mode of expression (including text, sound, image) that can be identified and converted to concept identification format. Because of this, the retrieval system provides a means for universal search of data by any mode of expression after the data has been stored by a concept former correctly with respect to the conceptual meaning of the data.

### DESCRIPTION OF THE DRAWINGS

The invention will be described in more detail with reference to the appended figures, in which

FIG. 1 shows a simplified example of a retrieval system and a data storage,

FIG. 2 shows a simplified example of the order index structure of a publication,

FIG. 3 shows a simplified example of several order index structures of a publication, and

FIG. 4 shows a slightly more detailed representation of the internal structure of the retrieval system in an example.

### DETAILED DESCRIPTION OF THE INVENTION

In the following description, specific definitions will be used for the purpose of understanding, and these definitions are intended to refer to those examples of the invention which will be presented in the figures and in the following more detailed description. Therefore, these definitions must not be unduly interpreted to limit the invention, because their meaning has been defined for this description. The definition “searchable data” describes the data storage in which the search is carried out. “Search argument data” refers to how the search is carried out and what is searched for, in other words what the searching person wants the retrieval system to look for. Consequently, the search argument data consists of at least one search expression. “Expression” refers to any way of presenting something. An expression may be a sign of a sign language, a written or spoken word of a spoken language, a word of a different language, a sound, a symbol, intervals, formulae, and integral and differential functions, etc. Single expressions of search argument data, such as words, are formed by means of a control system into “terms” which as transmitted as “inputs” into a concept former. The qualifier “input” thus refers to the terms and their appropriate combinations transmitted by the control system to the concept former. An “input” may thus comprise one or several terms which may, in this description, be referred to by the definitions “monoterm” or “polyterm”, respectively. The qualifier “concept” refers to something that forms a mental impression on a given subject matter to the receiver of the concept. A concept is not a word, although it is usually expressed by words of different form in different languages, but a concept may be constituted by an image, a sound, a code, or the like. For example, in the Finnish language, the concept “auto” (“car”, “auto-mobile”) may in some cases be expressed, for example, by the words “kaara”, “dollarihymy” as well as other expressions, such as the sound of a car in motion, the image of a car, etc. The essence of the present invention is that any single expression or several expressions are expediently converted to a given concept (in some cases, the same term may be interpreted in different ways in control systems for different specific purposes), wherein the search is implemented with said concept, and the search result is not strictly dependent on the search argument data entered by the searching person. It can thus be said that in the present invention, the search covers a set of terms that is wider than that defined by the user but means the same concept. The concepts do not belong to any language but they are thoughts and mental impressions of something that may be be expressed in different form in different languages. Consequently, if a sentence or a word is different in different languages, two people speaking different languages will get the same mental impression after hearing the same concept and will thus understand what is spoken about.

The qualifier “publication” describes the data storage in which the search is carried out. A publication is an indexable data source, and “order index of the publication” describes the arrangement in a given order of the data contained in the publication. The order index describes the priority order, and the same publication may comprise several different order indices. The data contained in the publication may be arranged in various orders, wherein it has various order indices. The qualifier “indexing rule” describes the way in which the data contained in the publication is indexed. Various indexing rules include, for example, the alphabetical order, the priority order, the numerical order, other conditions for comparison, etc. If the publication is a data storage containing e.g. data about various companies, these companies can be set in different orders according to the alphabet, the field of activities, size of the company, year of foundation, price, etc. Furthermore, the description of the invention deals with a “narrower” and a “wider” concept. A “wider concept” means that the narrower concept belongs substantially to a given set larger in view of the search. In other words, the “wider concept” includes narrower, more specified concepts, such as “sports equipment” covers a “football”, wherein sports equipment is a wider concept than a football (which is a narrower concept). Wider concepts can be stored in the content in a tree-like manner in connection with the indexing of data. The content may be stored to include a wider concept of the concent, and a wider concept for the wider concept, etc. The length of the branches will depend on the purpose of the retrieval system, the meaning of the segments of searchable data, as well as the quantity of data to be indexed. There may also be other factors in the length of a branch.

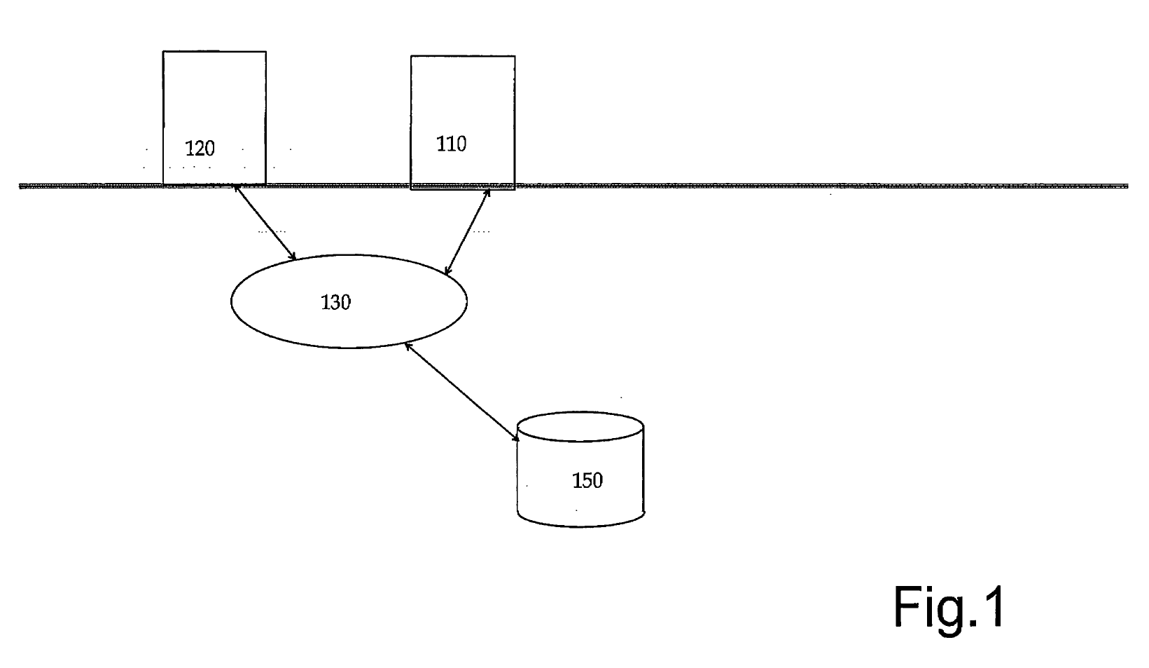

FIG. 1 shows one possible example of a retrieval system. In this example, the retrieval system 100 comprises a concept former 120, a concept matrix structure 110, and a control system 130. There may be several concept formers 120 and concept matrix structures 110 for a single control system 130, as well as there may be several control systems 130 for a single concept former 120 and a single concept matrix 110. Furthermore, the control system may be either independent or integrated in the rest of the software. It is obvious that the retrieval system may also comprise special means for performing the above-mentioned functions, wherein these means can be included as a part of a data storage containing the searchable data, or these means can be combined, in which case, for example, the program codes for executing these functions are within the same program segment. For the sake of clarity, however, these means are shown to be separate in this example. In this example, the concept former 120 and the concept matrix 110 communicate with the control system 130; in other words, they have interfaces and methods for communication with the control system 130. The concept matrix 110 and the concept former 120 do not need to communicate with anything else than the control system 130; consequently, they do not necessarily communicate with each other or with the data storage containing the searchable data or with any other external element. The data stored and transmitted by the concept former 120 and the concept matrix 110 should be formed as concise as possible, so that a minimum number of characters or a minimum quantity of data can be transmitted, with the result of data being transmitted as efficiently and fast as possible. This is achieved, for example, by transmitting the data in bit format between the concept matrix 110 and the control system 130. Furthermore, in the communication in the retrieval system 100, the data is transmitted as efficiently as possible, taking into account the properties of the network as a whole. Today, it is preferable to carry out the data transmission in large clusters, because several single requests may be slower due to the operations model and properties of the network. However, it is obvious that there are situations in which several single requests may be more efficient than more extensive requests. Realizing this, a person skilled in the art will appreciate that in the implementation of the invention, a method is used which maintains the efficiency and simplicity of the retrieval system.

The above-mentioned elements of the retrieval system 130 shown in FIG. 1, i.e. the concept matrix 110, the concept former 120 and the control system 130, may be arranged as independent devices and may be distributed, if necessary. In the distributed arrangement, the data transmission connection can be set up by using a cabled or wireless or any other data transmission connection. In a distributed system, the elements 130, 110, 120 can also be located physically in different premises. However, as already said, the retrieval system can also be a single device in which the means for implementing the function of the above-mentioned elements are integrated. Understanding these different embodiments of the retrieval system 100, a person skilled in the art will also appreciate the other possible variations of the retrieval system.

In this example, the retrieval system also communicates with the data storage 150. The number of data storages 150 may be one or several, and the retrieval system 100 may communicate with each of them. It is also possible to add and remove data storages connected to the retrieval system. The data storage may also be, for example, an auxiliary data structure embedded in the concept matrix. The auxiliary data structure can also be a program of its own which is requested for content or data according to the content segment. In this example, the data storage 150 and the control system 130 have a connection via which the control system 130 is arranged to retrieve the search result from said data storage. The data storage may be a local data storage comprising the data content of a given company, organization or the like, or the data storage may be global, wherein it comprises a more extensive data content.

The concept former 120 and the concept matrix 110 are programmed in such a way that they can be optimized to be as efficient, fast and storage saving as possible. Obviously, these elements can also be implemented in several programming languages. In an efficient arrangement, the concept former and concept matrix software uses, in its memory structure, the physical memory structure of a computer, or another fast memory structure. However, it is not excluded that this software could use a slower memory, such as a fixed disk. In some cases, the implementation of an intelligent search does not require a separate concept former and a concept matrix, because these functions and the sufficient properties can be implemented as a part of a ready-made database solution.

Building Up of the Retrieval System:

The function of the control system 130 is to bring the concept former 120 and the concept matrix 110 into function. The function of the control system 130 is to interpret what kind of information the searchable data (content of the data storage) is about. Control systems are designed and customized for different purposes, but still in such a way that the main functions of the control system remain the same. Examples of different control systems include, for example, a system for controlling company data search, and a system for controlling Internet contents. The control system may comprise a large number of conditional statements to recognize the appropriate terms of the search in various situations.

The control system is responsible for the introduction of the concept matrix and for the supplying of data in it. When coupled to the data storage 150, the control system 130 can upload the data belonging to the concept matrix 110 from the data storage 150 and transfer the data further to the concept matrix 110. Before the content is transferred to the concept matrix 110, the control system converts the data contained in the content segments into concept identifications by means of the concept former. In some cases, it is possible to use concept converters between separate retrieval systems. The function of a concept former will be described in more detail further below, but at this point it is said that the concept former is a storage of all the terms, for example words, that can be found in the searchable data of the database in question. For example, in a retrieval system based on text, a term can be identified by means of a line space, a special character or a character space, for example, after a single word or another character string. The system will process these single undivided terms as monoterms. Furthermore, the concept former is a storage of words, phrases or other entries which are significant for the search and are necessary for the retrieval system. The necessity is defined in the retrieval system on the basis of the context, also taking into account the needs for retrievability of the data contents and information obtained in practice on search terms used by searching persons. Also other data can be utilized and stored in the concept former, wherein it is obvious that this invention is not limited to the above-mentioned only. For example, log files can be used to parse commonly known search terms wherein these can be utilized in the concept former. When the control system requires a concept identification for some data, the control system transmits a request for it to the concept former which retrieves it. If no concept identification is found for a term in the data storage, the control system may request for a definition of this term from a person authorized to define concepts. This person defines and teaches concepts to the concept former; in other words, the person is an authority to define the concept identifications corresponding to the terms.

After receiving the concept identifications, the control system 130 transmits them to the respective segments in the content of the concept matrix 110. In other words, the concept identifications are stored in the concept matrix 110 in such a way that for each concept, the concept matrix 110 also knows the location of the content segment where the concept is found in said data storage. The data content of the data storage in the concept matrix 110 can be stored in a so-called content storage. In some systems according to the invention, the segment structure is not necessarily needed, whereas in other systems according to the invention, the segment structure may be tree-like, comprising several levels. In many cases, the concept is only stored once in a segment of contents, wherein memory space can be saved. Thus, the number of the concept in the respective content segment can be stored in connection with the concept. However, a person skilled in the art will appreciate the possibility that the concept is stored several times.

It is an idea of the invention that when each content is being stored (when the content is stored in the concept matrix via the control system), all the essential data that are relevant for the content, that relate to the search and that can be computed in advance, are computed in advance, and all possible conceptual links are analyzed in view of data searching and finding; and also information about discovered links is stored. The control system 130 forms the concept matrix 110 in such a way that the content of the used data storage is indexed in different order indices in the concept matrix, in the order complying to the order index specific indexing rules.

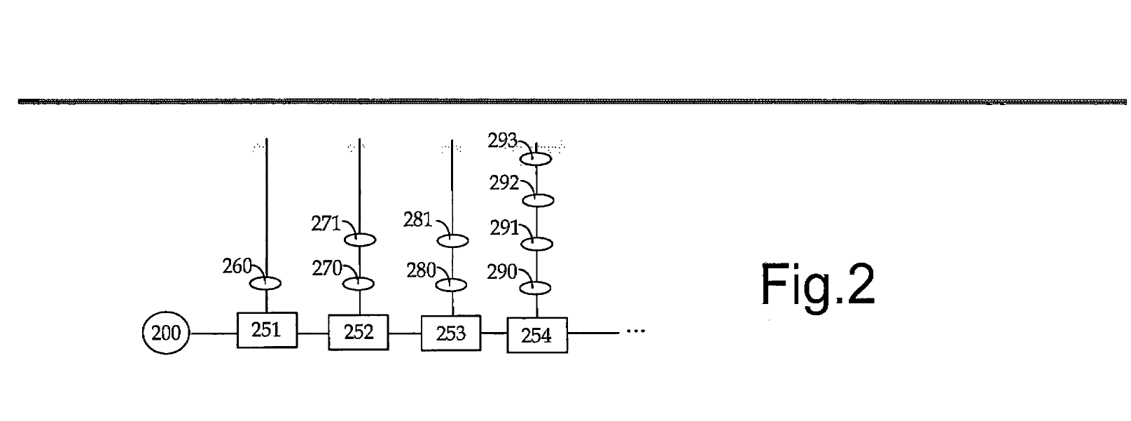

FIG. 2 shows the order index structure 200 of a publication, describing the content of a publication (a selected part or the whole of the content of the data storage) stored according to one order. The content of the order index structure is content segments stored (indexed) in concept identifications (251-254) in different orders. A different order is formed according to the order index 200 of said publication. In this way, the order index structure of the publication includes the concepts 251-254 occurring in said publication as well as information about the data segments (260, 270, 271, 280, 290, 291, 292, 293) in which said concept 251-254 occurs. Furthermore, these content segments are arranged according to the indexing rules of said order index 200.

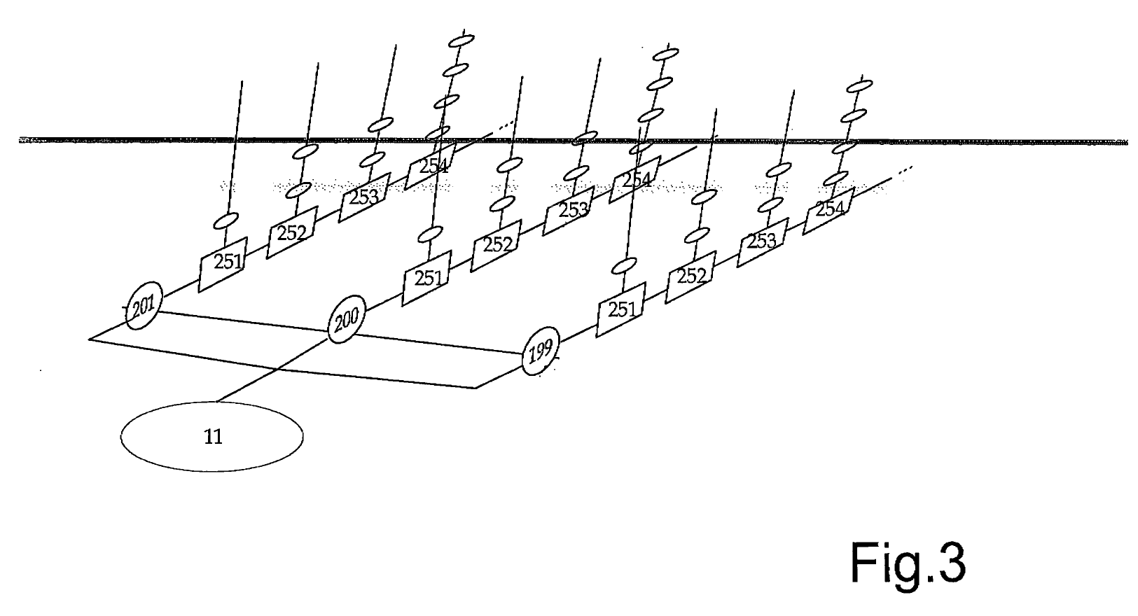

In FIG. 2, the order index 200 indicates the order in which the content segments (260, 270, 271, 280, 281, 290, 291, 293, 293), in which said concept 251-254 occurs, is stored in said concept. For example, if, according to the order index 200, the storing order is the alphabetical order, then those contents 290-293, in which said concept 254 occurs, are stored in alphabetical order under the concept 254. Consequently, as shown in FIG. 3, several order index structures 199-201 of the publication comprises the same content in relation to each other, the content corresponding to the content of the publication 11 divided according to the concepts 251-254 in an order indicated by the order index 199-201. Thus, one order index 200 can present the content of the publication 11 stored, for example, according to the concept in an alphabetical order, and another order index 199 can indicate, for example, that the content of said publication is stored according to the concept in an order of priority, and yet another order index 201 can indicate that the content of said publication is stored, for example, according to the concept in an order of updating date. In other words, each order index 199-201 contains the same data (from publication 11) stored according to the concepts (the concepts are the same, because the content is the same) in a different order as indicated by the indexing rules of the order index. For efficient retrieval of the search results, the search results are in the correct order of search results according to the indexing rules of the order indices. However, it should be obvious for a person skilled in the art that this does not exclude the possibility of rearranging the search results, if necessary, also in an order different from the indexing rules of the order indices. Each content segment comprises a content identification and a segment identification, by means of which said concept can be retrieved from the content storage. These identifications can be, for example, addresses of 32 bits.

As a result of such a solution, the order index structure of the publication comprises all the content segments in which each concept is found, ready in the correct order for the search results. As a result, a first search with one concept has thus been already carried out according to the selected order. If necessary, the control system 130 can divide the data content in several concept matrices. Several concept matrices will be needed, for example, when the retrieval system deals with such a large data storage that cannot be processed by a single computer with a sufficient efficiency or if the memory capacity of the computer is not sufficient.

The concept matrix formed is thus an efficient method for indexing the concepts. The role of the concept matrix 110 is such that it quickly provides information about the data content and the data content part or segment that constitutes the search result. Because all the data contents are divided into logical data segments in the concept matrix 110, the data content segment forming the search result is known by the concept matrix 110. As stated above, the concept matrix 110 consists of concept identifications by which the data content and its segments have been classified. Consequently, the concept matrix 110 does not store information other than the concept identifications. For this reason, the data content to be searched is made in as compact a format as possible. In this example, the concept identifications consist of 32 bits and they have a 32-bit pointer. For a person skilled in the art, it will be obvious that also identifications and pointers of other sizes are feasible.

Carrying out a Search in the Retrieval System:

The interpretation of search argument data is formed in a way similar to the method of introducing the above-described concept matrix.

When the control system 130 receives e.g. search argument data from a searching person (a user of a user interface connected to the retrieval system), the control system 130 interprets the data with the help of the concept former 120. The interpretation means the conversion of the search argument data into concept identifications and the formation of search criteria. It should be noted that the search argument data can be received in almost any expression and from almost any source. However, it is required that the control system 130 can interpret the expressions received, and transmit them to the concept former in such a format that the concept former can give concept identifications to the terms formed of it. In the following examples, it is assumed that the search argument data are composed of written search terms entered by the searching person in the retrieval system. The control system forms terms from the search argument data to be supplied to the concept former 120. For example, terms are formed from written search argument data by picking up the words occurring in the search argument data and forming appropriate mono- or polyterms of these words.

The control system 130 tries to find as large units as possible (as comprehensive and wide polyterms as possible) in the search argument data, i.e. to detect the phrases of several words in the search argument data. For these polyterms, such as also monoterms not belonging to the polyterms, the concept former 120 is requested to supply concept identifications to be utilized later on in the search operation.

The concept former 120 retrieves the concept identifications for those mono- and polyterms for which one is accessible. The concept former 120 may also retrieve information about possible basic forms of different terms. In a text-based search this means that for nouns, a singular form basic word is defined (pojille: poika), and for verbs, the first infinitive (kaipaisin: kaivata). For such monoterms that do not belong to any polyterm with concept identifications, it is still possible to make a new request with a polyterm formed of the basic forms of the respective monoterm, i.e. with a dynamic polyterm.

If no concept identification is found for some single monoterm (or another unit, i.e. the smallest possible unit occurring in the search argument data), then said concept identification cannot be found in the concept matrix 110 either, because it is not possible to store anything in the concept matrix 110 that is not found in the concept former 120. Thus, if the search argument data contains a so-called AND search—in whose search result all the concepts must occur—the search ends here and the concept matrix thus does not need to be included in the search operation.

For example, if the search argument data contains five words, A B C D E, the control system 130 will group them so that it simultaneously requests the concept former 120 for all the occurring words/character strings and their appropriate absolute combinations. The concept former 120 will thus retrieve not only the concept identifications found for the terms but also the concept identification of their basic form, if the terms were in another form when output from the control system 130. By means of the concept identifications obtained for the basic forms of the terms, the control system 130 requests the concept former 120 for the concept identifications of the so-called dynamic phrases formed of the basic forms of the words or character strings.

It is also possible that the control system 130 groups the five words, A B C D E, in such a way that it first asks the concept former 120 for all these five words and tries to find a concept identification for their combination. Then, if it is not found, the control system goes on requesting with formations of four words (A B C D, B C D E) and formations of three words, two words and single words, until the concept identifications have been obtained.

The function of the concept former 120 is thus to record concept identifications and to provide information on these identifications. The concept former 120 attempts to find the concept identifications for the terms contained in the input received from the control system 130. Consequently, the concept former 120 contains terms and their concept identifications, and knows which monoterm or polyterm corresponds to which concept identification. Furthermore, the concept former 120 may contain arguments or informative data about the concept and term in question, for example whether the term is a synonym of another term, because their concepts are the same, whether the term in question is in genitive form, or whether the concept describing the term can be classified as useless for the search or its interpretation. This definition can be implemented, for example, by marking such a concept with an auxiliary identification, i.e. an argument. It should be noted that concepts can also be marked to be so-called important concepts, or a concept can be given another marking describing its quality. Furthermore, one concept may have more than one marking. In general, all such concepts are marked with arguments which are appropriate for the search or its interpretation and are useful in view of efficiency or a better interpretation as well as functionality. Useless concepts may include, for example, verbs, adverbs, conjunctions, prepositions, as well as auxiliary, intermediate and expletive words. The needlessness or uselessness of a concept is often specific to the field or case and is thus related to the case-specific interpretation of data. Yet another example to be mentioned is a situation in which a word-format concept formed of a single term may have several meanings which are separated by the corresponding arguments. On the basis of these arguments as well as other concepts in the same context, the control system is adapted to form the search criteria for later use.

The concept former 120 is also arranged to transmit these arguments to the control system 130 if it requests for them. The argument data can be presented, for example, as a 32-bit identification which can be interpreted by the control system. However, it is obvious that the argument data can also be presented in another way.

If the concept former 120 retrieves a concept identification (one or more), the search can be carried out. The control system 130 asks the concept matrix 110, how many content segments and/or contents (numbers of occurrences) said concept has. If the concept former 120 has also retrieved, as argument data, that any of the concepts is a so-called useless concept for the search process, the control system 130 will not ask for the numbers of occurrences for this concept. If the concept matrix 110 gives zero as an answer to the question about the number of occurrences of the concept, the search is ended, when it is a limiting search, such as e.g. an AND search. On the basis of the numbers retrieved, the concepts included in the search and the interpretation of the argument data, the control system 130 forms the search criteria and the conditions of comparison for the concept matrix 110. It is the function of the control system 130 to interpret what type of data the person using the search wants, and to select the most appropriate search criteria for carrying out the search. In other words, the control system 130 attempts to find a motive for the search, wherein this motive is used to select a first or determining concept by which the search can be limited in the concept matrix as much as possible. As a result, it will not be necessary to scan through all the data content in the concept matrix. The search criteria also include the concept identifications selected by the control system, that is, the concepts which the control system finds useful for carrying out the search. The search criteria also include the selection of an order index for the publication, the selection of the conditions of comparison, etc. The selection of the order index may be determined by the search user interface used by the searching person, or the control system can select the order index of the publication via the interpretation of the search argument data, i.e. the input from the searching person. For the search, an attempt is made to find a so-called determining factor of the concepts formed of the terms, to limit the search and to select a content segment index for the concept of the order index of the publication, for searching the segments of the contents indicated. The search criteria formed by the control system 130 are transferred to the concept matrix 110 which carries out the search according to the criteria.

The search in the concept matrix is carried out in an approriate way, because the content of the data storage has been stored concept by concept in the concept matrix. Thus, when the control system allocates the concept matrix one or more concept identifications, the index structure of the concept matrix 110 makes it easier to start the search. Furthermore, the data on the number of occurrences given by the concept matrix 110, i.e. the number of contents and/or content segments for each concept identification, are also utilized in the search operation. This number data can be utilized for determining the most efficient order of comparison between the concepts in the search. In other words, the invention is based on the idea of selecting, as the reference concept, the concept identification with the smallest number of content segments, wherein the need for comparing other concepts is as small as possible. For example, if concepts A and B and C are searched for, the number of content segments is 135 for A, 530 for B and 3 for C. To obtain the result A and B and C, the obtained content segments must be compared with each other. As already said, in the solution according to the invention, the search is based on the idea that it is useless to scan through, for example, the search results of B and to look for A and C in them, when the search can be carried out in the search result of C, to look for A and B there. Consequently, the search must only be carried out in three contents. In this way, a high speed is obtained in the search. It is known that in may retrieval systems of prior art, the search includes a comparing scanning through all the data contents and involves work that is unnecessary in the solution of the invention.

After the concept matrix 110 has found information about the concept identification index in whose content segments the search should be carried out, the other concepts are compared with the concepts of the contents included in the selected concept index. In other words, for the first concept which limits the set of results most, the search has been carried out in advance, wherein the actual process of comparing/searching in real time is considerably simpler than the conventional retrieval process.

After the concept matrix 110 has carried out the search operation, it retrieves the results in the format required by the control system 130. The control system 130 interprets the retrieved result and, by means of the concept identifications therein as well as the content and content segment pointers, forms the search result relevant for the searching person, in cooperation with the content storage in which the search result data relevant for the retrieval system has been stored.

By means of the retrieval method according to the invention, it is also possible to carry out searches in a data storage in a different language. For example, a Russian company wanting to find a subcontracting company in Finland may use e.g. a Russian version of a retrieval service of Finnish companies, or a service with a reference to said retrieval service. In such a situation, only a “concept converter” is needed between the search data. The search can be carried out in such a way that a concept former, which is capable of converting terms of another language to concepts, converts the Russian request to concept identifications. After this, these concept identifications are compared with Finnish concept identifications and are converted to correspond to the Finnish ones, unless these two languages have a common concept database. The conversion tells which concepts in one language correspond to concepts in the other language, wherein a search in the content in the other language can be carried out.

The control system 130 can be used for carrying out a search operation via an electronic user interface, for example an Internet browser. The user interface for using the control system may be located in any device equipped with a data transmission connection, in which it can be implemented. Examples of such devices are personal computers and portable terminals, such as laptop computers or mobile phones and personal digital assistants.

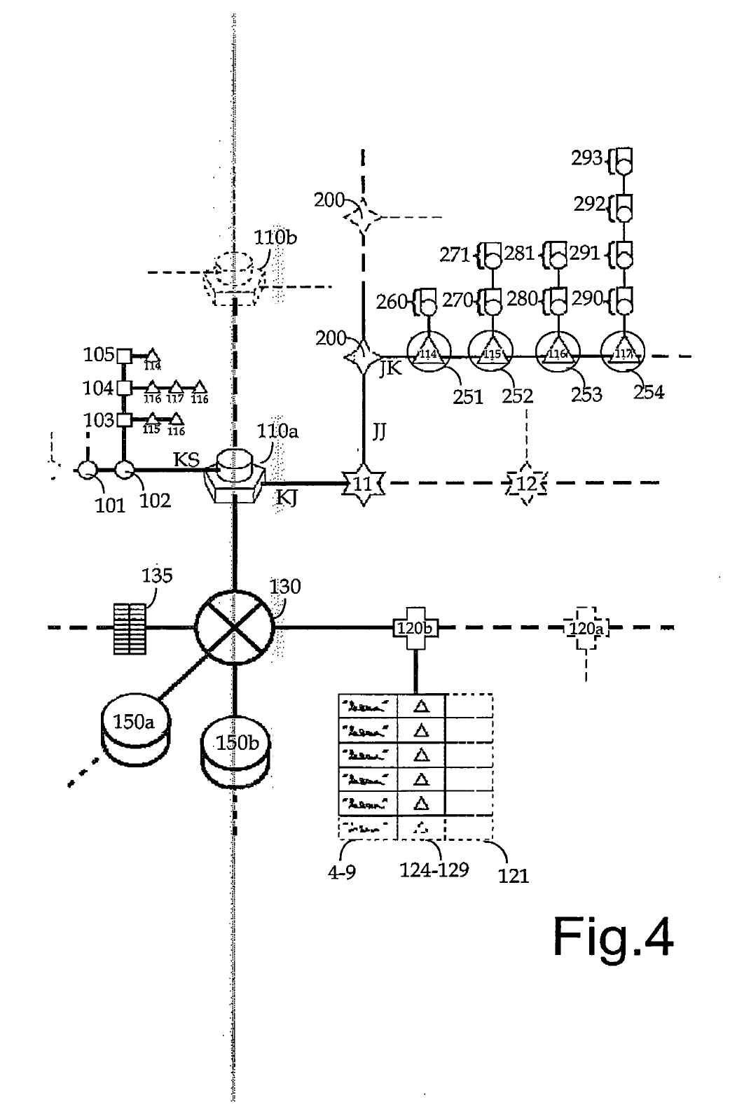

One example of a retrieval system is presented in more detail in FIG. 4. From the example of FIG. 4, it can be seen that the control system 130 comprises a connection to data storages 150a, 150b and to a concept identification converter 135. The control system 130 is also connected to one or more concept formers 120a, 120b, each storing data on character strings 4-9 and on the respective concept identifications 124-129. Furthermore, argument data 121 can be stored in the concept former 120a, 120b. Further, the control system 130 is connected to one or more concept matrices 110a, 110b. The concept matrix 110a contains an order index structure (KJ) of publications of the concept matrix, containing one or more publications 11, 12. These publications 11, 12, further contain at least an order index structure (JJ) of the publications, comprising one or more order indices 200, 201. These order indices 200, 201 represent the order of occurrence of data stored in the concept index structure (JK) of the order index. The concept index structure (JK) contains a content segment index 251-254 for the concept, indicating that it is a concept (114, 115, 116, 117) as well as information about the content segments relating to said concept. The content segment indices 251-254 may include counters, from which e.g. the number of content segments for said concept can be seen. The content segment indices 251-254 also include content segment references 260-293 stored in the order of occurrence according to the order index 200.

The concept matrix 110 also has a content storage (KS) of one or more contents, each content including segments 103-105 and concepts 114-119 occurring in said segments and obtained from the concept former 120a by means of stored data. FIG. 4 shows the extent of the retrieval system that makes fast and efficient searches possible. In the system shown in FIG. 4, a search “B and C” (where B and C represent concept identifications marked in the figure as data 116 and 117 included in content segment indices 253, 254, respectively) can be carried out by first examining, on the basis of the search criteria, what is the desired order in the set of results, and then selecting the corresponding order index 200 in the retrieval system. After this, the concept with the smallest number of content segments is selected as the concept for comparison. In the example of FIG. 4, it can be seen that the concept C (254(117)) has four content segments whereas the concept B (253(116)) has two content segments, wherein it is advantageous to select the concept B as a reference concept. From the content segment index 253, the content segment references 280, 281 relating to the concept are found out, leading to the content storage (KS) of the concept matrix 110a. In this example, it can be assumed that the content segment reference 280 corresponds to the content 102 and the segment 103, and the content segment reference 281 corresponds to the content 102 and the segment 104, in which the concept B (116) is thus known to exist. A search is carried out in these content segments (102, 103) (102, 104) to look for the occurrence of the concept C (117). Because the search was a so-called AND search, both concepts must occur in the set of results. Consequently, it can be found that the content segment (102, 104) also includes the concept C (117), wherein this content segment can be retrieved as a result to the control system 130 which retrieves the corresponding content from the data storage 150a.

In this example, all the content segments were so-called allowed content segments. However, it may be that one of the segments of the content 102 or the content itself is defined red, wherein this segment is not scanned through even if there were a reference to it from the content segment index. In a corresponding manner, one of the segments of the content 102 or the content is defined green, wherein the segment is taken into account even though there were no indication to it.

Example of a Company Search

In this example, a searching person uses a text-based searching user interface to define the search argument data “transports in Hesa surroundings”, which is received in the control system 130. The control system 130 chops the search argument data down to parts and transmits the parts and their appropriate combinations or terms to the concept former 120. The concept former 120 finds, for the occurring terms, the concept identifications and their requested arguments as well as possible basic forms of the terms and their concept identifications and possible arguments.

The first (or absolute) term inquiry takes place as follows:

For the sake of simplicity, we shall first define
“transports”=a
“in Hesa”=b
“surroundings”=c,
   wherein in this example, the concept former retrieves the following result:

The transmitted term/combination of terms=the retrieved basic form of the concept=the retrieved concept identification

a = A = id
b = B = id
c = C = id
ab = null = null
bc = null = null
abc = null = null

Using the search terms in the example, the concept former retrieves the following results:

| | | | concept id for |
|---|---|---|---|
| Search term | concept id | basic form | basic form |
| transports | id1 | transport | id2 |
| in Hesa | id3 | Helsinki | id4 |
| surroundings | id5 | surrounding | id6 |
| transports | null | null | null |
| in Hesa | | | |
| in Hesa | null | null | null |
| surroundings | | | |
| transports | null | null | null |
| in Hesa | | | |
| surroundings | | | |

A second request of terms which is a dynamic request of words in basic form, based on the first inquiry, is made as follows:

AB = null = null
BC = bc = id
ABC = null = null

And by using the actual terms:

| | | | concept id for |
|---|---|---|---|
| Search term | concept id | basic form | basic form |
| transport | null | null | null |
| Helsinki | | | |
| Helsinki | id7 | Helsinki region | id8 |
| surrounding | | | |
| transport | null | null | null |
| Helsinki | | | |
| surrounding | | | |

From these results, it is seen that the most significant concept identifications in view of the search are id2 and id8, which are transferred to the concept matrix. The concept matrix 110 looks for the data content numbers corresponding to each concept identifications, wherein the result is, for example, id2=5 and id8=35. Because both concepts must occur in the search result, the search is carried out by comparing the concept identification id8 with the set of search results of the concept identification id2, wherein the comparison must be made between the appropriate segments of five contents only. It is essential to notice that the concept identification id2 does not contain the term “transport” only but also other such terms whose concept corresponds to transport; for example, the term “van rentals” has formed, in its content segments, a concept corresponding to transport, if the term has been defined as a wider search concept of said concept.

Logical Operators in Search Argument Data

The above described examples have been implemented, as a default, as an AND search, wherein each term must occur in the search results. An OR search, in which either of the terms is in the search results, can be implemented in three different ways: If the comparison conditions of the search criteria have both AND elements and OR elements, that concept index of the defined concepts which limits the search as much as possible is selected as the AND element, and the other AND and OR elements are compared with the content segments referred to by the selected concept index. If the search clause has only two alternatives, “ID1 OR ID2”, the search is carried out on each identification separately. Thus, two ready sets of results are obtained from the two concept indices, one containing the search results for the concept identification ID1 and the other with the search results for the concept identification ID2. In some cases, the search results may also contain search results fulfilling the condition “ID1 AND ID2”, whereby this search result may occur twice in connection with each identification. This can be avoided by carrying out a further checking between the sets of results. It is also feasible to carry out a comparison in more OR cases, but a comparison, combination and arrangement of more OR inquiries becomes too slow for processing large quantities of data with machine powers available at the time of writing the application. In comparison conditions of search criteria containing OR elements only, it is possible to use that concept index of the order index of the publication which consists of the content segments containing any concept (containing all the content segments of a publication in the order according to the indexing rules of the order index). Thus, all the contents of the publication are searched for all the concepts defined in the search criteria.

In addition, it is also possible to use such operators that define search terms to be used in a way different from that described above. For example, in the present invention, it is possible to use a so-called OBS operator (OBServe) for searching the term defined by it, but its finding does not affect the contents or segments to be retrieved. In other words, the OBS comparison will notice the occurrence of a term but will not limit the search by it. The search result will retrieve the finding of the observed term but the term does not affect the search in other respects.

In the retrieval system, it is most appropriate to find one defining factor to minimize the need for a comparison in real time with an index limiting the search, after which it is possible to use any comparison operator, OR, NOT, XOR, or the like. It is obvious that the present invention does not limit to the use of these logical operators only, but they can be replaced by some operation terms, symbols, functionalities (functions, formulae, methods [for example in object programming]), etc.

Compounds and Misspellings

In the processing of compound words, the control system can interpret the search argument data and the search results to define what was meant by the input entered by the user. In this example, the user has written “doll” “houses” when “dollhouses” were meant. In connection with data systems equipped with a retrieval system of the present invention, in whose context the input “doll houses” can almost without exception be interpreted as a concept corresponding to the term “dollhouse”, the concept former can be taught to understand the term “doll houses” as a concept corresponding to the term “dollhouse”. This can be done by taking into account the form of the term accurately, wherein the term is taught as an absolute polyterm “doll houses”. The interpretation can also be expanded to apply to combinations of different forms of inflective forms of single words, i.e. monoterms, wherein the term must be taught as a dynamic polyterm “doll house”, in which the smallest parts of the polyterm, i.e. the monoterms “doll” and “house” are as monoterms in their basic form. When interpreting the dynamic polyterms of the entry by the searching person, the control system assembles the polyterms from the basic forms of the monoterms, wherein the polyterm will match, the words included in the term being in any form recognized by the concept former. In both cases, the misspelled term can be automatically interpreted as an appropriate concept. For the misspelled term, an argument has been included, which can be transmitted by the concept former to the control system, if necessary. By means of the argument, the control system may inform the user interface of the data searching person on the interpretation of the misspelled term and, if necessary, transmit a request to check the input to be sure about the correct interpretation of the search.

If no concept identification is found for the term occurring in the search clause, the concept former may define the term unidentified and retrieve this information as an argument to the control system. The control system may request the user to enter the word again. The control system adds the unindentified monoterms occurring in the search argument data in the teaching list of the concept former. The control system requests the teacher of the concept former to teach the unidentified terms of the list to the concept former with a user interface designed for concept former teaching.

Implementation

As presented in the beginning of the this description, the retrieval system can be implemented as software comprising elements familiar with concept forming, the functions and control of the concept matrix. Furthermore, the retrieval system is connected with at least one data storage. The data storage may be almost any system specialized in the processing of data, containing a necessary memory structure, such as a database, to which the control system is coupled. The source material of the retrieval system can be interpreted as concepts in connection with the storage of the material or parts of the material, after which the data is immediately retrievable from the retrieval system. The retrieval system is thus, according to its use, a dynamic retrieval system which can be updated either in almost real time or—for example in the case of Internet pages—at certain intervals. The source data may also be produced by external authorities, wherein the control system picks up the amended data at regular intervals and thus updates the retrieval system, wherein the retrieval as concepts from the retrieval system is possible with respect to the amended data. The amended concept data are updated as the control system receives the data both in the concept former and the concept matrix. Furthermore, the retrieval system may also comprise other data storages or systems for expanding the field of use of the retrieval system, for example speech recognizers or surveillance cameras.

The retrieval system is updated and taught by people with the necessary knowledge on the terms and concepts of each language and field. These people teach the concept former and operate with the control system. There may be separate user interfaces for the concept former and the concept matrix as well as for the control system. The concept matrix is updated according to the updating of the concept former or the data storage. In other words, all the contents in which a given concept is changed for another concept identification, or the concept is amended, the concept matrix is updated accordingly. For example, when the data storage is modified via the control system, the control system notifies the concept matrix and the concept former that certain concepts have been updated so that the concept former and matrix should also be updated for the amended data. The concept former and the concept matrix are constructed so that they detect the searches carried out during the updating and can, if necesary, stop the updating for the time of carrying out the search. In this way, the retrieval process is fast even in connection with updating. The updating is continued again after the search has been carried out. It is true that the updating can be continued even during the search, because in multiprocessor systems, the updating process does not significantly slow down the searching. In multiprocessor systems, even several search operations can be carried out simultaneously, without the operations slowing down each other. The persons updating the source data do not need to understand the functionality of the retrieval system. The source data can be any material understood by the concept former, and the source data do not need to be an integrated part of the retrieval system.

As the control system is adapted to determine the running of the search function and the search criteria, the control system can also decide on limiting the search. For example, if the data complying with the search criteria is found in a given content segment, the search can be extended even further by a decision of the control system. The control system can define, for example, green (that is, essential for the search) and red (that is, useless or harmful for the search) segments, the contents of the green segments being always included in the search and the contents of the red segments being not included. Consequently, it is possible to define common segments to be included in addition to the segments meeting the search criteria. According to the search, it is also possible to define segments to be searched by defining, in addition to the content segments of the concept index, also other content segments to which the search is to be expanded and in which the search is not allowed.

For example, when searching for company data, it is essential to include in the comparison such segments that contain general information about the firm (e.g. name, address), wherein the data of the firm can be found even if the content of the concept index to be compared referred to another content segment.

Without the above-mentioned functionality, a search in which a search for a firm is carried out on the basis of the name and address would not find the required firm when the name and the address are located in different content segments. Consequently, it is important that some of the content segments of, for example, company data are defined, case by case, as content segments essential for the search, wherein these segments are included in the comparison in any case, with respect to the contents of the selected concept index.

The retrieval system according to the invention is capable of performing complex comparisons fast, because it knows many things in advance, limits the search in a most appropriate way, reduces data into a format which is more efficient for the retrieval and the comparison, as well as keeps the significant data—in view of the efficiency of the search—in the physical memory of a computer. Thanks to the rapidity of the search, the retrieval system is capable, if necessary, in a situation in which it does not find the search results, of forming partial search results and suggesting the user that “No results are found with this search clause but if concept X is deleted, a search result will be obtained.” In other situations, the retrieval system can also carry out a search automatically without a given word.

In some cases, the speed of the search makes it possible that the search can be carried out automatically again even by excluding concepts which are less relevant for the search. Such concepts include e.g. adjectives that are often used unnecessarily to specify the searchable data. Thus, the person searching for data can be informed that the interpretation of the search has been expanded and the terminology of the search argument data has been reduced.

It is obvious that various embodiments of the invention can be produced by combining the above-presented examples of the invention. Therefore, the above-presented examples must not be interpreted as restrictive to the invention, but the embodiments of the invention may be freely varied within the scope of the inventive features presented in the claims hereinbelow.

1. A method for forming a data retrieval system, the method comprising:
receiving a data content, and
defining concepts for the expressions occurring in the data content,
wherein the received data content is modified by forming concepts corresponding to the expressions, resulting in the creating of at least one structure comprising the concepts describing the expressions of the data content as well as the locations of these concepts in said data content.

2. The method according to claim 1, wherein in said structure, the content segments of the data content are stored in a different order for each concept occurring in the segment.

3. The method according to claim 1, wherein the location of said concept in said data content is stored in said structure as a pointer of said data content.

4. The method according to claim 1, further comprising forming concepts for the expressions by defining concept identifications for them.

5. The method according to claim 2, further comprising defining an order index to describe the order of the content segments containing the concept.

6. The method for carrying out a data search in a data retrieval system formed by the method according to claim 1, wherein data comprising one or more search terms are received, the method further comprising searching concepts for one or more search terms occurring in the search argument data, forming at least by means of the concepts search criteria to search for the locations in the data content corresponding to said one or more concepts in said at least one structure.

7. The method according to claim 6, further comprising defining a determining factor which is the largest possible combination of terms for which one concept is found.

8. The method according to claim 6, further comprising searching for concept identifications and possibly auxiliary information for one or more search terms occurring in the search argument data.

9. The method according to claim 6, further comprising requesting for the numbers of locations corresponding to one or more concepts in said data content, and selecting, as the reference concept, the concept with the smallest number of content segments.

10. The method according to claim 6, further comprising defining also an order of occurrence, in which order of occurrence the locations corresponding to the concept in the data content are adapted to be retrieved.

11. The method according to claim 6, further comprising forming the search criteria on the basis of at least the order of occurrence, the reference concept, the decisive factor, the concept identifications, and possible auxiliary information.

12. The method according to claim 6, further comprising carrying out the search by comparing other concepts with at least such contents that comprise the reference concept.

13. The method according to claim 6, further comprising retrieving said locations in the data content on the basis of the location looked for in the structure.

14. The method according to claim 6, further comprising receiving search argument data in such a form of expression which is one of the following group: graphic expressions, audiovisual expressions, binary expressions.

15. A data retrieval system comprising means for transmitting data to one or more data contents, interaction means for receiving search argument data, as well as means for carrying out a search in said one or more data contents, the data retrieval system comprising:
control means for defining searchable data and search argument data,
interpreting means for converting the searchable data and search argument data into concepts, and
at least one structure for storing the data content in concept format.

16. The data retrieval system according to claim 15, wherein said structure is adapted to store the content segments of the data content in a different order for each concept occurring in the content segment.

17. The data retrieval system according to claim 15, wherein said structure is adapted to store the location of said concept in said data content as a pointer of said data content.

18. The data retrieval system according to claim 15, wherein said structure is adapted to retrieve the numbers of occurrences of the locations of each concept, of which the control means are adapted to select the concept with the smallest number of occurrences as a reference concept.

19. The data retrieval system according to claim 15, wherein said control means are adapted to convert the search argument data into terms as well as to request for concept identifications for these one or more terms from said concept form, as well as to define a determining factor which is such largest possible combination of terms for which one concept is found.

20. The data retrieval system according to claim 15, wherein said interpreting means are adapted to retrieve concept identifications for the search argument data, as well as possible auxiliary information.

21. The data retrieval system according to claim 15, wherein said control means are also adapted to define the order of occurrence, in which order of occurrence the locations representing the concept in the data content are adapted to be retrieved.

22. The data retrieval system according to claim 15, wherein the control means are adapted to set up the search criteria by means of the search identifications, the reference concept, the order of occurrence, and possible auxiliary information.

23. The data retrieval system according to claim 15, wherein the data retrieval system is adapted to process data in such a form of expression which is one of the following group: graphic expressions, audiovisual expressions, binary expressions.

24. A data structure for a data retrieval system and a data content, the data structure comprising:
order indices describing the orders of occurrence, and
identifications describing the data of the data content, wherein each identification can be used to search for the data content segments including said identification in the order of occurrence indicated by the order index.

25. A computer software product stored in a storage means for forming an information retrieval system, the computer software product comprising:
computer executable instructions which have been adapted to receive a data content and to define concepts for the expressions occurring in said data content, and further to convert the received data content by forming corresponding concepts for said expressions, with the result of creating at least one structure which includes the concepts describing the expressions of the data content as well as the locations of these concepts in said data content.

26. A computer software product stored in a storage means for carrying out a data search, the computer software product comprising:
computer executable instructions to receiving search argument data comprising one or more search terms, wherein the computer instructions have been adapted to retrieve concepts for one or more search terms occurring in the search argument data, to form, by means of the concepts, search criteria for searching for locations in the searchable data content corresponding to said one or more concepts in the structure.
